(19) United States
(12) Patent Application Publication
(10) Pub. No.: US 2021/0040652 A1
(43) Pub. Date: Feb. 11, 2021

(54) IN-LINE MACHINE

(71) Applicants: Roberto TROVI, Quarrata (PT) (IT); Franco DOLFIN, Vignola (Modena) (IT); Piero TONINI, Pistoia (IT); Antonio CASO, Pistoia (IT)

(72) Inventors: Roberto TROVI, Quarrata (PT) (IT); Franco DOLFIN, Vignola (Modena) (IT); Piero TONINI, Pistoia (IT); Antonio CASO, Pistoia (IT)

(21) Appl. No.: 16/965,863

(22) PCT Filed: Feb. 7, 2019
(86) PCT No.: PCT/IB2019/050986

§ 371 Date: Jul. 29, 2020

(30) Foreign Application Priority Data
Feb. 8, 2018 (IT) 102018000002502

(51) Int. Cl. D01G 11/02; D06H 7/22

(52) U.S. Cl. CPC D01G 11/02; D06H 7/221

(57) ABSTRACT

A machine for recycling quilts includes an infeed station, configured to receive as input a quilt consisting of a plurality of layers joined by stitching, a heating station, including heating means configured to increase the temperature of the stitching to a change of state or softening temperature of a heat-sensitive sewing thread, a separating station, comprising traction means, acting on the plurality of layers for moving them in respective diverging directions.

### TECHNICAL FIELD

This invention relates to the field of quilts.

More specifically, the invention relates to a machine and a method for recycling quilts.

### BACKGROUND ART

The quilting of textile products is a production process carried out by linking together textile structures, by means of suitably positioned and spaced stitches, which often also comprise support or padding materials.

The quilting allows multilayer or padded textile products to be made which are embellished with the selection of textures and patterns defined by the switching on the outer layers.

It is therefore a very widespread process for making of goods which are aesthetically pleasing, such as: furnishing fabrics, non-woven fabrics for padding, mattresses, bedspreads, baby items and fashion items.

Due to the large diffusion of quilted products, and thus the volume and the value of the materials which they use, the need is increasingly felt to find new methods for their recycling and for simplifying the existing processes, to favour the re-use of the parts and the fibres contained therein once they have reached the end of their life.

Is also known that the industrial production of quilted products and the use of the same quilted products for the industrial production of goods generates a significant quantity of industrial waste, comprising fabrics and non-fabrics which are often in excellent condition, sewn together in layers. In particular, the multi-needle machines for quilting fabrics for mattresses require, to obtain a good quality result, the cutting of a significant edge portion of the product produced and its rejection.

For economic and environmentally-friendly reasons, it would always be preferable to recycle the waste cuttings deriving from industrial production of quilts, but in order to do so it is necessary separate the layers and the padding, in such a way as to direct each of these to the specific area for recycling.

Disadvantageously, removal or cutting the stitching between the various layers which make up a quilted product is a complicated and laborious operation, which risks irreversibly damaging or deforming the various layers to be reused.

Due to the cost and time related to the operation for separating the various layers, it is quite common to completely abandon both the recycling of quilted products at the end of their life and the production offcuts, which are generally discarded in the form of waste, with a significant economic and environmental cost linked to the processing of this waste, both for the individual and for the general public.

### DISCLOSURE OF THE INVENTION

In this context, the technical purpose which forms the basis of the invention is to provide a machine and a method for recycling quilts which overcome at least some of the above-mentioned drawbacks of the prior art.

More specifically, the aim of the invention is to provide a machine and a method for recycling quilts which is able to reduce the work load, the complexity and the economic cost of recycling quilts.

A further aim of this invention is to provide a machine and a method for recycling quilts which is able to reduce the environmental impact of the production of quilts and encourage their recycling.

The technical purpose indicated and the aims specified are substantially achieved by a machine and a method for recycling quilts, comprising the technical features described in one or more of the accompanying claims. The dependent claims correspond to possible different embodiment of the invention.

Further features and advantages of this invention are more apparent from the non-limiting description which follows of a preferred non-limiting embodiment of a machine and a method for recycling quilts.

### BRIEF DESCRIPTION OF THE DRAWINGS

The description is set out below with reference to the accompanying drawings which are provided solely for purposes of illustration without restricting the scope of the invention and in which:

FIG. 1 shows a schematic view of a machine for recycling quilts made according to the invention in a configuration of use;

FIG. 2 shows a schematic view of an alternative embodiment in accordance with the invention;

FIG. 3 shows a construction detail of the machine of FIGS. 1 and 2.

### DETAILED DESCRIPTION OF PREFERRED EMBODIMENTS OF THE INVENTION

With reference to the drawings, a machine for recycling quilts, according to the invention, is denoted in its entirety by the reference numeral 100.

The machine 100 is configured for processing recyclable quilts. The term “recyclable quilts” generically means quilts comprising a plurality of layers joined together by a stitching comprising at least one heat-sensitive sewing thread.

Preferably, the quilt 1 according to the invention comprises at least an upper layer 10 and a lower layer 20, preferably made of fabrics for furnishing and bedding items such as, for example, cotton, linen, silk, synthetic fibres or a combination of these. Without limiting the scope of the invention, both the upper layer 10 and the lower layer 20 may be formed by a single piece of fabric or comprise a plurality of pieces of fabric sewn together. They may also consist of non-woven fabrics, for example spunbonded, or equivalent materials such as leather, faux leather and leatherette.

The quilt 1 also comprises a padding 30 interposed between the upper layer 10 and the lower layer 20 and made, for example, of goose plumage or cellulose wadding or other natural or synthetic fibres.

The upper layer 10 and lower layer 20, located on respective opposite sides of the padding 30, are joined by means of a stitching 40, which constrains them along predetermined lines and it is formed by a plurality of stitches, distributed along the above-mentioned predetermined lines. The stitching 40 is configured in such a way as to enclose and compress the padding 30 between the two upper 10 and lower 20 layers by means a variable force according to the desired properties of softness, weight and elasticity and the type of padding 30 used.

The stitching 40 of the quilts 1 configured for recycling using the machine 100 comprises a heat-sensitive sewing thread, that is to say, characterised by a change of state or softening temperature approximately between 50° C. and 200° C., preferably between 70° C. and 140° C., however significantly less than a temperature of degradation, change of state or combustion of the rest of the quilt 1. Depending on the embodiment, the stitching 40 may be made entirely of heat-sensitive sewing thread or from a combination of sewing threads, of which at least one heat-sensitive, to form a plurality of stitched points configured in such a way that the dissolution of the heat-sensitive sewing thread allows the fast break up of the stitching 40.

The machine 100 comprises an infeed station 110, configured to receive as input a quilt 1 of the type described above and convey it towards subsequent processing stations. In a preferred but non-limiting embodiment, the machine 100 is configured for the connection in line with a quilting machine in such a way as to automatically receive as input fabric waste cuttings produced by the quilting machine. This solution is particularly suitable for multi-needle quilting machines for mattresses, which produce a large quantity of waste cuttings.

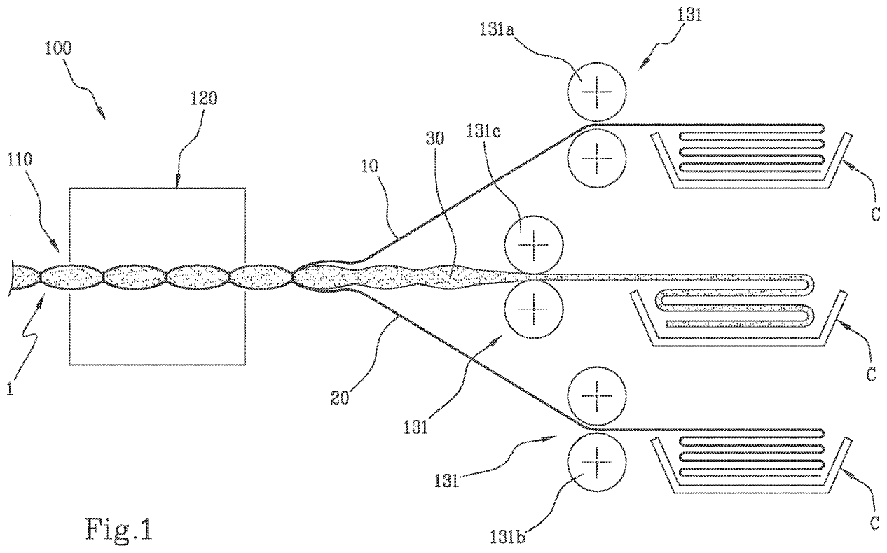

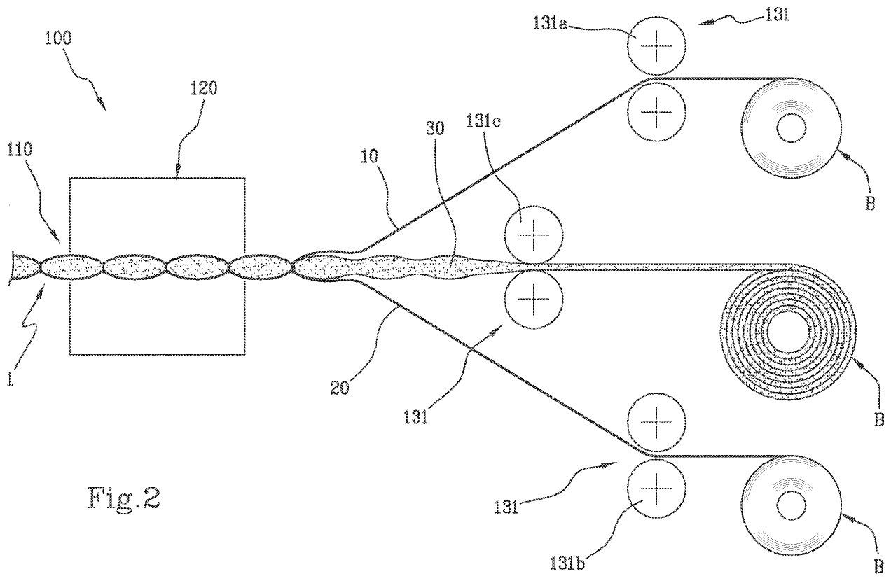

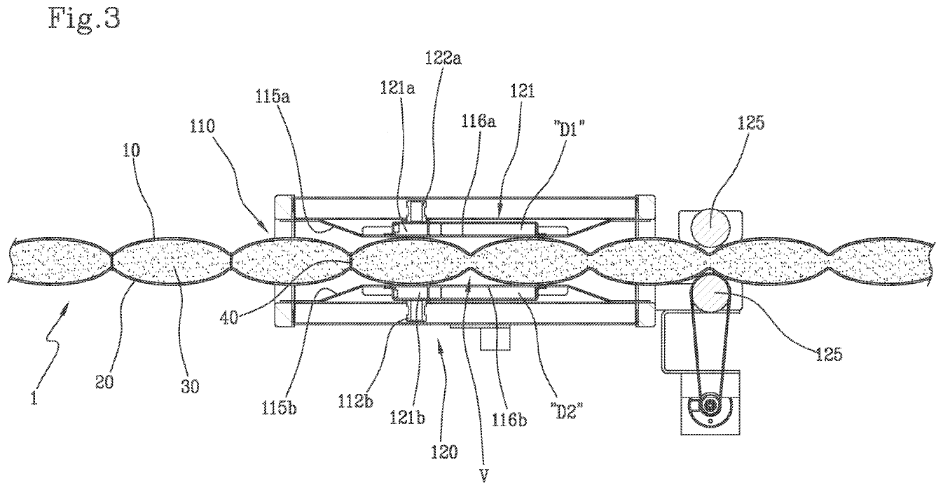

The machine 100 also comprises a heating station 120, connected in line with the infeed station 110, shown schematically in FIGS. 1 and 2 and in detail in FIG. 3. The heating station 120 comprises heating means 121, acting on a heating space ‘V’ designed to contain a portion of the quilt 1 coming from the infeed station 110.

The heating means 121 are configured to increase the temperature of the stitching 40, and in particular of the above-mentioned heat-sensitive sewing thread, to a of change of state or softening temperature of it, without damaging the other components of the quilt 1. They are therefore configured for heating the above-mentioned stitching 40 to a temperature higher than a change of state or softening temperature of the heat-sensitive sewing thread and lower than a temperature of degradation of the rest of the quilt 1, wherein the other components are subject to changes of state or combustion. Preferably, the temperature is between 50° and 200° C., preferably between 70° C. and 140° C.

The machine 100 also comprises supporting means 115 adapted to convey the quilt 1 coming from the infeed station 110 into the heating space ‘V’. Preferably, the support means 115 comprise opposite walls 115a and 115b, facing and converging towards the heating space ‘V’.

Preferably, the heating means 121 comprise an upper heating device 121 a and a lower heating device 121b, associated with the supporting means 115 positioned on opposite sides of the heating space ‘V’.

In the preferred embodiment, the heating means 121 comprise steam diffusers at a temperature; in alternative embodiments they comprise infrared lamps and/or inductive coils.

In the embodiment illustrated, the supporting means 115 comprise a pair of perforated walls 116a and 116b, located on opposite sides of the heating space ‘V’ to allow the passage of steam at temperature towards it. Preferably, the upper 121 a and lower 121b heating devices comprise respective collectors 122a and 122b, connectable to a source of steam at a temperature. Moreover, they define respective diffusion chambers [symbol] T and [symbol] 2′ in fluid communication with the above-mentioned collectors 122a and 122b and with the holes of the perforated portions 116a and 116b.

In an embodiment not illustrated, the heating means 121 comprise a system for adjusting the distance of the steam diffusers from the heating space ‘V’, in such a way as to adjust the intensity of the jet which reaches the quilt 1 and the size of the surface in question.

Preferably, the heating means 121 comprise a sensor configured for detecting the presence of material in the heating space ‘V’ or in the infeed station 110 and directed towards the heating station 120. The sensor is connected to a control unit configured to control the heating means 121 as a function of a signal coming from the sensor, in such a way as to activate a heating action at the arrival of a quilt 1 in the heating space ‘V’ and deactivate it when there is no quilt 1 in the above-mentioned space.

Advantageously, the heating means 121 are configured to cause a softening or at least partial dissolution of the stitching 40 in such a way as to neutralise or significantly weaken the joining action of the various layers of the quilt 1, so as to allow a separation of the layers by a pulling of each in divergent directions, without this casing significant damage.

Preferably, the machine 100 also comprises a pair of drive rollers 125, facing each other in a counter-rotating fashion and configured to move the quilt 1 through the heating station 120. In the embodiment illustrated, one of the drive rollers 125 is motor-driven whilst the other is pulled.

Subsequently, the machine 100 comprises a separating station 130, wherein the drive means 131, act on the layers of the quilt 1 for moving them in a divergent direction and separating them from each other, after the stitching 40 joining the layers has been dissolved in the heating station 120.

In the embodiment illustrated, the drive means 131 comprise a pair of motor-driven rollers for each layer of the quilt 1, in particular two pairs of rollers 131 a and 131 b acting respectively on the upper layer 10. If the padding 30 of the quilt 1 constitutes a layer which is compact and resistant to traction, for example a layer of wadding, the drive means 131 comprise another pair of rollers 131c acting on the padding 30.

Advantageously, in the configuration of use of the machine 100, the traction means 131 are configured to direct the various layers of the quilt 1 towards a zone for compacting them.

Preferably, the machine 100 is configured for conveying the layers of the quilt 1, after the separation, into a respective storage space, preferably defined by external containers ‘C’, as illustrated in FIG. 1. In an alternative embodiment, illustrated in FIG. 2, the machine 100 is configured to wind the layers of the quilt 1 on respective winding reels ‘B’, for storing them.

Another object of the invention is a method for recycling quilts, which can be implemented using the machine 100 described above.

Preferably, the method according to the invention is applicable to waste cuttings produced by quilting machines and comprises a first step of picking up a quilt 1 of the type described above from a quilting machine. Alternatively, the method according to the invention may applied to finished quilts, to be recycled as they are worn or damaged, and in this case the above-mentioned step is omitted.

The method according to the invention comprises a step of moving a quilt 1, of the type described above, through a heating space ‘V’ and a step of heating the stitching 40 to a of change of state or softening temperature of a heat-sensitive sewing thread of which it is composed, using the methods described above relative to the machine 100.

Preferably, the step of heating the stitching 40 is achieved by directing a jet of steam towards an upper surface, or a lower surface, of the quilt 1, or a step of directing a jet of steam towards both the surfaces of the quilt 1. The method then comprises a step of mutually separating the layers of the quilt 1, preferably by pulling the above-mentioned layers in divergent directions.

Lastly, the method comprises a step of placing the various layers in respective containers ‘C’ or wrapping them layers around respective winding reels ‘B’.

The present invention achieves the present aims, overcoming the disadvantages of the prior art. More specifically, the machine and the method described above allow the mutual separation of the various layers of a recyclable quilt, specifically made for this type of application. Advantageously, the possibility of separating the layers of the quilted

fabrics allows an economically worthwhile recycling, limiting the economic and environmental costs linked to their disposal.

1. A machine for recycling quilts, comprising:
an infeed station configured to receive as input a quilt comprising a plurality of layers joined by a stitching.
a heating station, comprising heating means acting on a heating space designed to contain a portion of the quilt, the heating means being configured to increase the temperature of the stitching to a change of state or softening temperature of at least one heat-sensitive sewing thread of the stitching;
also comprising a separating station downstream of the heating station, the separating station comprising traction means, acting on the plurality of layers for moving the layers in respective diverging directions and separating them from each other, after the stitching has been heated in the heating station.

2. The machine according to claim 1, wherein the heating means comprising an upper heating device and a lower heating device, the heating station defining the heating space between the upper heating device and the lower heating device.

3. The machine for recycling quilts according to claim 1, comprising supporting means designed to convey the quilt into the heating space (V).

4. The machine according to claim 1, wherein the heating means comprise steam diffusers at a temperature.

5. The machine according to claim 3 wherein the supporting means comprise a pair of converging walls, facing each other to form a guide towards the heating space, and a pair of perforated walls, positioned downstream of the converging walls and facing the heating space to allow the passage of steam at a temperature towards the heating space.

6. The machine according to claim 4, wherein the heating means comprise a system for adjusting the distance of the steam diffusers from the heating space.

7. The machine according to claim 1, wherein the heating means comprise a sensor designed to detect the presence of the quilt in the infeed station or in the heating station, or upstream of the stations, a control unit being configured controlling a heating action of the heating means as a function of a signal coming from the sensor.

8. The machine according to claim 1, comprising a pair of drive rollers, facing each other in a counter rotating fashion and configured for moving the quilt through the heating station, at least one of the drive rollers being motor-driven.

9. The machine according to claim 1, configured for conveying at least one of the layers, after the separating station, to a respective storage space, preferably defined by an external container (C).

10. The machine according to claim 1, configured to wind at least one of the layers on a respective winding reel.

11. The machine according to claim 1, configured for the connection in line with a quilting machine in such a way as to receive as input waste cuttings of quilted fabric produced by the quilting machine.

12. The machine according to claim 1, wherein the heating means are designed for heating the stitching to a temperature of between 50° C. and 200° C., preferably between 70° C. and 140° C.

13. A method for recycling quilts, comprising the steps of:
moving a quilt, comprising a plurality of layers joined by stitching, through a heating space;
heating the stitching to a change of state or softening temperature of at least one heat-sensitive sewing thread;
mutually separating the layers of the quilt.

14. The method according to claim 13, wherein the step of heating the stitching comprises a step of directing a jet of steam towards an upper surface of the quilt and/or a step of directing a jet of steam towards a lower surface of the quilt.

15. The method according to claim 13, comprising a step of placing at least one of the layers in a respective container and/or wrapping at least one of the layers about a respective winding reel.

16. The method according to claim 13, wherein the quilt is a waste produced by a quilting machine and the method comprises a step of picking up the waste from the quilting machine.
